(19) United States
(12) Patent Application Publication
(10) Pub. No.: US 2026/0340645 A1
(43) Pub. Date: Oct. 29, 2026

(54) SYSTEMS AND METHODS FOR GENERATING DYNAMIC SECURITY CODES

(71) Applicant: Fiserv, Inc., Milwaukee, WI (US)

(72) Inventors: Chandra Mouli YALAMANCHILI, Brookfield, WI (US); Amy L. CRINKLAW, Brookfield, WI (US); Daniel F. CROSS, Brookfield, WI (US); Vijay Vinood WILLIAM THOMAS, Brookfield, WI (US)

(73) Assignee: Fiserv, Inc., Milwaukee, WI (US)

(21) Appl. No.: 19/188,661

(22) Filed: Apr. 24, 2025

Related U.S. Application Data
(60) Provisional application No. 63/649,023, filed on May 17, 2024.

(51) Int. Cl. G06Q 20/40

(52) U.S. Cl. CPC G06Q 20/4018

(57) ABSTRACT

A method may include receiving a request for a dynamic security code (DSC) for a transaction using a transaction card and, in response to the request, generating the DSC a first time based on a pseudo-random number and card data of the transaction card including a card type of the transaction card, transmitting the DSC to a cardholder device, storing the card data of the transaction card and the pseudo-random number, receiving, via a payment network, an authorization request for a transaction, the authorization request including the DSC, and generating the DSC a second time based on the card data of the transaction card and the pseudo-random number to authorize the transaction.

### CROSS-REFERENCE TO RELATED APPLICATIONS

This application claims priority to US Provisional Application No. 63/649,023, filed May 17, 2024, which application is incorporated herein by reference.

### BACKGROUND

Card verification numbers are used to provide security to transactions performed with transaction cards. For card-not-present transactions, a card verification number, such as a card verification code (CVC) or card verification value (CVV or CVV2) may be used. The card verification number is generally printed on a transaction card.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure relate to a method including receiving a request for a dynamic security code (DSC) for a transaction using a transaction card, in response to the request, generating the DSC a first time based on a pseudo-random number and card data of the transaction card including a card type of the transaction card, transmitting the DSC to a cardholder device, storing the card data of the transaction card and the pseudo-random number, receiving, via a payment network, an authorization request for a transaction, the authorization request including the DSC, and generating the DSC a second time based on the card data of the transaction card and the pseudo-random number to authorize the transaction.

In some implementations, the method includes receiving the authorization request including the DSC includes receiving the DSC in a field of the authorization request corresponding to a card verification number. In some implementations, the card data of the transaction card includes a card number of the transaction card. In some implementations, the card type of the transaction card corresponds to a payment network associated with the transaction card. In some implementations, the method includes receiving, via the payment network, a second authorization request including a static card verification number, and generating, based on the card data of the transaction card, the static card verification number to authorize the transaction. In some implementations, the method includes storing an algorithm for generating the DSC, wherein generating the DSC the first time and the second time, based on the card data of the transaction card and the pseudo-random number, includes generating the DSC using the stored algorithm. In some implementations, the stored algorithm is included in a group of stored algorithms, and wherein generating the DSC the first time and the second time, based on the card data of the transaction card and the pseudo-random number, includes selecting the stored algorithm based on the card type of the transaction card. In some implementations, the method includes determining the card type of the transaction card and a payment network associated with the transaction card based on a card number of the transaction card. In some implementations, the pseudo-random number is an incremented number. In some implementations, the method includes, in response to the authorization request including a static card verification number, generating, based on the card data of the transaction card, the static card verification number, and in response to the authorization request including the static card verification number, authorizing the transaction based on issuer preferences.

Aspects of the present disclosure are directed to a non-transitory, computer-readable medium including instructions which, when executed by one or more processors, cause the one or more processors to receive a request for a dynamic security code (DSC) for a transaction using a transaction card, and in response to the request, generate a first time, based on a pseudo-random number and card data of the transaction card including a card type of the transaction card, the DSC, transmit, to a cardholder device, the DSC, store the card data of the transaction card and the pseudo-random number, receive, via a payment network, an authorization request for a transaction, the authorization request including the DSC, and generate a second time, based on the card data of the transaction card and the pseudo-random number, the DSC to authorize the transaction.

In some implementations, the instructions cause the one or more processors to receive the authorization request including the DSC by receiving the DSC in a field of the authorization request corresponding to a card verification number. In some implementations, the card data of the transaction card includes a card number of the transaction card. In some implementations, the card type of the transaction card corresponds to a payment network associated with the transaction card. In some implementations, the instructions cause the one or more processors to receive, via the payment network, a second authorization request including a static card verification number, and generate, based on the card data of the transaction card, the static card verification number to authorize the transaction. In some implementations, the instructions cause the one or more processors to store an algorithm for generating the DSC, wherein the instructions cause the one or more processors to generate the DSC the first time and the second time, based on the card data of the transaction card and the pseudo-random number, by generating the DSC using the stored algorithm. In some implementations, the stored algorithm is included in a group of stored algorithms, and wherein the instructions cause the one or more processors to generate the DSC the first time and the second time, based on the card data of the transaction card and the pseudo-random number, by selecting the stored algorithm based on the card type of the transaction card. In some implementations, the instructions cause the one or more processors to determine the card type of the transaction card and a payment network associated with the transaction card based on a card number of the transaction card. In some implementations, the pseudo-random number is an incremented number. In some implementations, the instructions cause the one or more processors to, in response to the authorization request including a static card verification number, generate, based on the card data of the transaction card, the static card verification number, and in response to the authorization request including the static card verification number, authorize the transaction based on issuer preferences.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of an environment in which dynamic security codes (DSCs) can be created and used.

FIG. 2 is an example flow diagram of a method for creating a DSC.

FIG. 3 is an example flow diagram of a method for using a DSC to authorize a transaction.

FIG. 4 is an example flow diagram of a method for generating a DSC to authorize a transaction.

FIG. 5 is an example block diagram of a computing system 500.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to generating a dynamic security code (DSC) for a card-not-present transaction in order to improve a security of the transaction. Card-not-present transactions, such as online transactions or telephone transactions, generally call for the card number, the expiration date, and a card verification number, such as a card verification value (CVV or CVV2) or a card verification code. The card verification number is generally a three or four-digit number printed on the transaction card. The card verification number is used to confirm that a customer has the card in their possession, but as the card verification number is printed on the transaction card, anyone who has seen or has a picture of the transaction card or who has the transaction card in their possession can attempt a card-not-present transaction using the card verification number. Embodiments discussed herein provide for generating a DSC for a transaction using transaction card data and a pseudo-random number. When a transaction is initiated, a DSC is requested and generated using the transaction card data and the pseudo-random number. A cardholder can receive the DSC and enter the DSC in a card verification number field of a transaction. In this way, a conventional authorization request can be used with the DSC in place of a static card verification number. When the authorization request is received, the DSC is re-generated for comparison with the DSC received in the authorization request. The transaction can be authorized based on the DSC sent to the cardholder matching the re-generated DSC. By re-generating the DSC, instead of storing the DSC, a security of the DSC is improved. The DSC can be used in conventional authorization requests, allowing for seamless integration in conventional payment processing channels. Furthermore, by generating the DSC based on a card type of the transaction card or payment network associated with the transaction card, the DSC can be adapted for use in conventional authorization requests for a variety of payment networks.

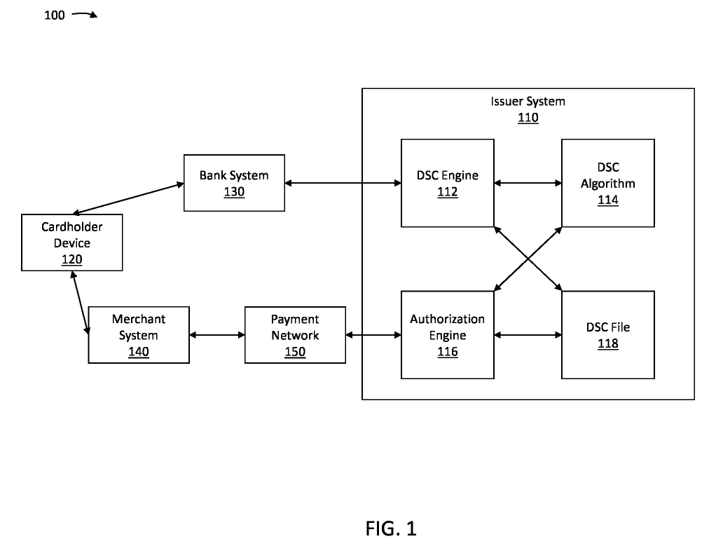

FIG. 1 is an example block diagram of an environment 100 in which dynamic security codes (DSCs) can be created and used. The environment 100 includes an issuer system 110. The issuer system 110 may create the DSCs for use in transactions. The environment 100 includes a cardholder device 120, a merchant system 140, and a payment network 150.

Conventional transactions may be handled by the cardholder device 120 transmitting transaction card data to the merchant system 140 which routes the transaction card data to a payment network 150 which routes the transaction card data to the issuer system 110. The transaction card data for conventional transactions may include a static card verification number printed on the transaction card. DSCs can be created for increased security and can be routed through the same authorization channels as conventional transactions.

The issuer system 110 may receive a request for a DSC from the cardholder device 120. In some implementations, the environment 100 includes a bank system 130. The cardholder device 120 may send the request for the DSC to the bank system 130 which sends the request for the DSC to the issuer system 110. In some implementations, the request for the DSC is associated with a specific transaction. The issuer system 110 creates the DSC and transmits the DSC to the bank system 130 or cardholder device 120.

The cardholder device 120 (or another device associated with the cardholder) provides the DSC to the merchant system 140. The cardholder device 120 may be a mobile device, a laptop, a desktop computer, a tablet, or any computing device. The merchant system 140 may provide a website on which the cardholder provides transaction card data including the DSC. The cardholder may provide the DSC in a field used for static card verification numbers. In this way, the DSC can be used with the existing merchant system 140 and/or the merchant website without requiring modification for use of the DSC.

The merchant system 140 submits a transaction authorization request to the payment network 150 which routes the authorization request to the issuer system 110. Based on the authorization request including the DSC, the issuer system 110 approves the transaction and sends an approval message to the payment network 150 which transmits the approval to the merchant system 140. The merchant system 140 indicates to the cardholder device 120 the success of the transaction. In an example, the merchant website indicates that the transaction was successfully completed.

The issuer system 110 may include a DSC engine 112, a DSC algorithm 114, an authorization engine 116, and a DSC file.

The DSC engine 112 may receive the request for the DSC from the bank system 130 or the cardholder device 120. The bank system 130 may be associated with a bank or other entity that issued the transaction card. The issuer system 110 may be a system which supports the bank system 130 by providing transaction authorization services. The DSC engine may generate the DSC using transaction card data and a pseudo-random number. The transaction card data may include a card number of the transaction card and/or a card type of the transaction card. In some implementations, the card type of the transaction card is associated with the corresponding payment network 150 and can be determined based on the card number. The pseudo-random number may be an incremented number, such as a number incremented each time a DSC is created. The DSC engine 112 may use the DSC algorithm 114 to generate the DSC using the transaction card data and the pseudo-random number. The DSC engine 112 may store the transaction card data and the pseudo-random number in the DSC file 118. Preferably, the DSC engine 112 stores the transaction card data and the pseudo-random number in the DSC file 118, but does not store the DSC in the DSC file 118 to increase a security of the DSC. The DSC engine 112 may transmit the DSC to the bank system 130 or the cardholder device 120. The DSC engine 112 may increment the pseudo-random number based on the DSC being created. The pseudo-random number may be stored in the DSC file 118. In some implementations, a current pseudo-random number indicates how many DSC have been created and a pseudo-random number stored in association with a transaction indicates the number used to generate the DSC for the transaction. The current pseudo-random number may be stored at the DSC engine 112 while transaction-specific pseudo-random numbers are stored in the DSC file 118. The DSC file 118 may include an identifier of a transaction and corresponding transaction card data, pseudo-random number, and DSC generation algorithm, such as the DSC algorithm 114.

The authorization engine 116 may receive the authorization request from the payment network 150. The authorization engine 116 may determine whether a DSC was requested for the transaction and query the DSC engine 112 for the DSC. The DSC engine 112 may retrieve the transaction card data and the pseudo-random number from the DSC file 118 and generate the DSC a second time using the DSC algorithm 114. By using the same transaction card data, the same pseudo-random number, and the same DSC algorithm 114, the DSC can be re-generated for comparison with the DSC received in the authorization request without storing the DSC. In some implementations, the authorization engine 116 re-generates the DSC by retrieving the transaction card data and the pseudo-random number from the DSC file 118 and generate the DSC a second time using the DSC algorithm 114.

In some implementations, the DSC algorithm 114 is implemented using a hardware security module. Generating the DSC using the DSC algorithm 114 may include sending the transaction card data and the pseudo-random number to the hardware security module and receiving the DSC from the hardware security module.

The authorization engine 116 compares the DSC retrieved in the authorization request to the generated DSC to authorize the transaction. Based on the DSC retrieved in the authorization request and the generated DSC matching, the authorization engine 116 authorizes the transaction and sends the approval message to the payment network 150.

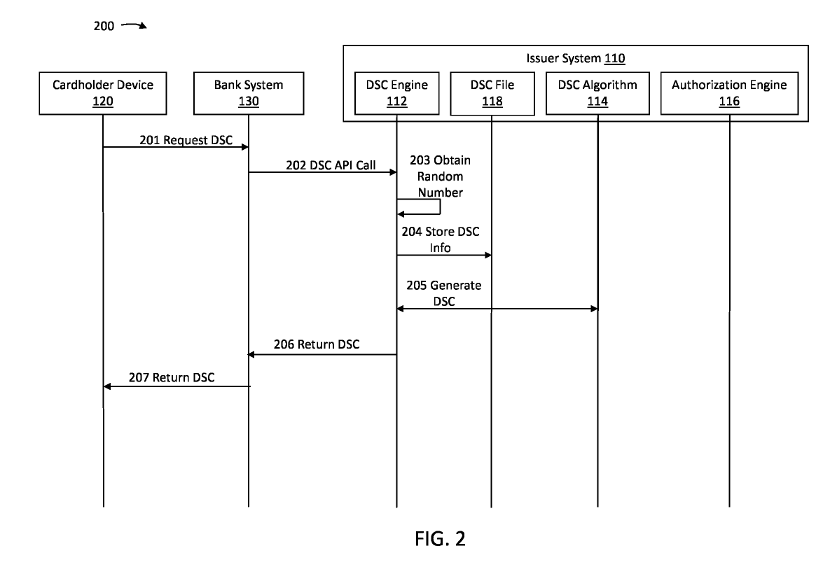

FIG. 2 is an example flow diagram of a method 200 for creating a DSC. The method 200 may include more, fewer, or different operations than illustrated. The method 200 may be performed by the components of the environment 100 of FIG. 1. The method 200 may be performed by the issuer system 110 of FIG. 1.

At operation 201, the cardholder device 120 sends a DSC request to the bank system 130 which makes a DSC API call to the DSC engine 112 at operation 202. In some implementations, the bank system 130 makes the API call at operation 202 to the issuer system 110 which routes the API call or makes an internal API call to the DSC engine 112. The DSC request may include transaction data of a transaction, including transaction card data of a transaction card used for the transaction.

At operation 203, the DSC engine 112 obtains the pseudo-random number. The DSC engine 112 may generate the pseudo-random number, may look up an incremented number, and/or obtain a pseudo-random number from the DSC file 118. At operation 204, the DSC engine stores the DSC information in the DSC file. The DSC information may include the transaction card data and the pseudo-random number used to generate the DSC.

At operation 205, the DSC engine generates the DSC using the transaction card data, the pseudo-random number, and the DSC algorithm 114. In some implementations, the DSC engine 112 accesses the DSC algorithm 114 to generate the DSC. In some implementations, the DSC engine 112 transmits the transaction card data and the pseudo-random number to the DSC algorithm 114 and receives the DSC in response. In an example, the DSC engine 112 sends the transaction card data and the pseudo-random number to a hardware security module implementing the DSC algorithm 114 and receives the DSC in response.

At operation 206, the DSC engine 112 returns the DSC to the bank system which transmits the DSC to the cardholder device 120. In the method 200, the cardholder device transmits the DSC request to the bank system 130 and receives in response the DSC.

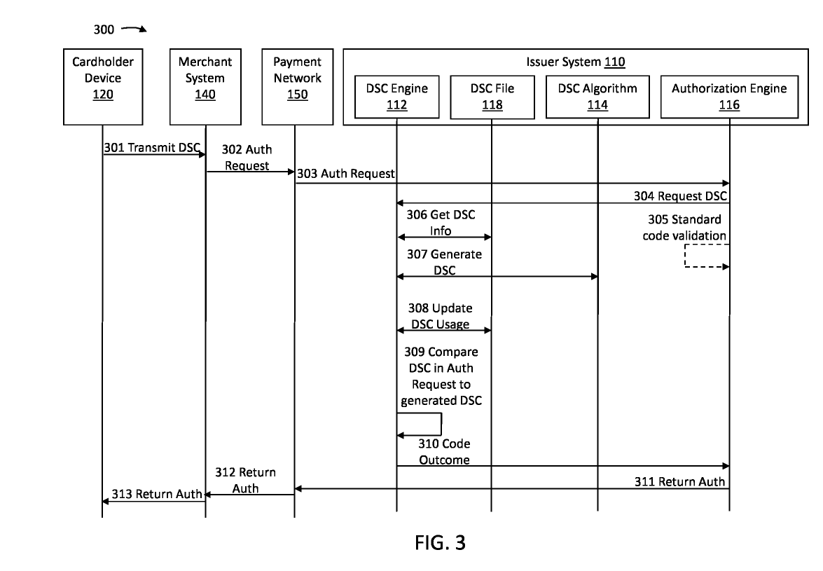

FIG. 3 is an example flow diagram of a method 300 for using a DSC to authorize a transaction. The method 300 may include more, fewer, or different operations than illustrated. The method 300 may be performed by the components of the environment 100 of FIG. 1. The method 300 may be performed by the issuer system 110 of FIG. 1. The method 300 may be a continuation of the method 200 of FIG. 2, implementing the DSC generated in the method 200.

At operation 301, the cardholder device 120 transmits the DSC to the merchant system 140. The cardholder device 120 may transmit the DSC to the merchant system 140 using a website of the merchant system 140. In an example, the cardholder enters the DSC in a transaction field for a card verification number, such as a CVV2 or CVC. At operation 302, the merchant system 140 transmits an authorization request including the DSC to the payment network 150 which routes the authorization request to the authorization engine 116 at operation 303. The authorization engine 116 determines whether a DSC was requested for the transaction. If a DSC was not requested for the transaction, the authorization engine 116 conducts a standard code validation at operation 305, using a static card verification number. If the DSC was requested for the transaction, the authorization engine 116 requests the DSC from the DSC engine 112 at operation 304.

At operation 306, the DSC engine obtains DSC information from the DSC file including information used to generate the DSC, such as the card number and the pseudo-random number. At operation 307, the DSC engine 112 uses the DSC algorithm 114 to generate the DSC. At operation 308, the DSC engine 112 updates the DSC usage at the DSC file 118. In some implementations, the DSC engine 112 updates the DSC usage to indicate that the DSC has been used and that the DSC information no longer needs to be store in the DSC file 118. In some implementations, the DSC engine 112 updates the DSC usage to increment the pseudo-random number.

At operation 309, the DSC engine 112 compares the DSC received in the authorization request to the generated DSC. The DSC engine 112 may determine whether the DSC received in the authorization request and the generated DSC match. At operation 310, the DSC engine 112 sends the code outcome to the authorization engine indicating whether the DSC received in the authorization request and the generated DSC match. In some implementations, the static card verification number is included in the authorization request instead of the DSC. The DSC engine 112 may, based on issuer preferences, determine whether to compare the received static card verification number to the static card verification number for the transaction card to authorize the transaction, or whether to decline the transaction. The DSC engine 112 may indicate in the code outcome that the received number does not match the DSC and/or that the received number matches the static card verification number. In some implementations, the authorization engine 116, upon receiving a negative code outcome from the DSC engine that the received number does not match the generated DSC, compare the received number to the static card verification number.

At operation 311, the authorization engine 116 sends an authorization message to the payment network 150. At operation 312, the payment network 150 sends the authorization to the merchant system 140 which communicates the authorization to the cardholder device 120 at operation 313. Conversely, if the transaction is declined, the declined status or disapproval is sent through the payment network 150 and merchant system 140 to the cardholder device 120. The authorization request and the approval/disapproval may be the same as used in conventional transactions, but for the inclusion of the DSC in the field for the card verification number in the authorization request. In this way, the issuer system 110 is able to provide increased security within the conventional payment channels and using the conventional authorization request and approval message.

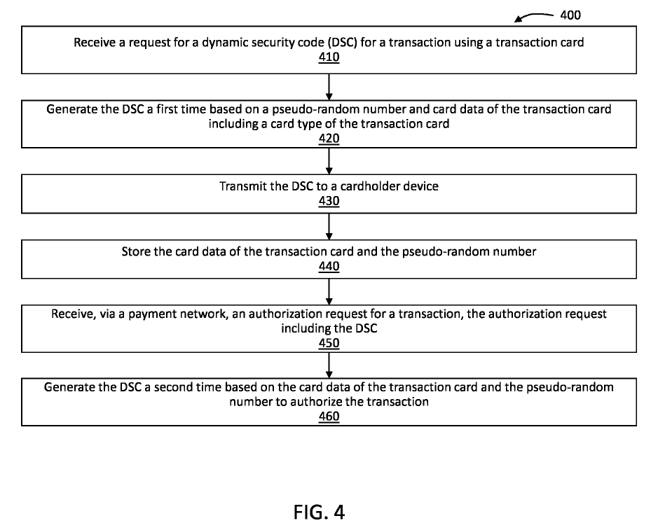

FIG. 4 is an example flow diagram of a method 400 for generating a DSC to authorize a transaction. The method 400 may include more, fewer, or different operations than illustrated. The operations may be performed in the order shown, in a different order, or concurrently. The method 400 may be performed by one or more components of the environment 100 of FIG. 1. The method 400 may be performed by the issuer system 110 of FIG. 1.

At operation 410, a request is received for a DSC for a transaction using a transaction card. The transaction may be a card-not-present transaction. The request may be received from a cardholder device and/or a bank system. In an example, the cardholder device requests the DSC for the transaction based on user input. In an example, the cardholder device requests the DSC from the bank system and the bank system makes an API call to request the DSC. In some implementations, the request may be automatically generated. In an example, a user can specify that a DSC should be requested for each card-not-present transaction conducted using the transaction card. In this way, the user can request that a DSC be generated for each transaction such that a DSC is generated in response to each transaction.

At operation 420, the DSC is generated a first time. The DSC is generated based on a pseudo-random number and card data of the transaction card, including a card type of the transaction card. In some implementations, the card data of the transaction card includes a card number of the transaction card. In an example, an algorithm is executed using as input the card number of the transaction card and the pseudo-random number to generate the DSC. In some implementations, the card type of the transaction card corresponds to a payment network associated with the transaction card. The DSC may be generated differently based on the card type of the transaction card and/or the payment network associated with the transaction card. In an example, a first payment network uses card verification values having three digits and a second payment network uses card verification values having four digits and the DSC is generated to match the number of digits used by the payment network associated with the transaction card. In this way, DSCs can be generated for a variety of payment networks and can be used in fields corresponding to card verification values.

In some implementations, the pseudo-random number is an incremented number. In an example, the pseudo-random number is a number that is incremented based on time. In an example, the pseudo-random number is a number that is incremented each time a new DSC is generated. The pseudo-random number may be kept secret such that to an outside observer, the DSC appears to be generated using a random number.

At operation 430, the DSC is transmitted to a cardholder device. The cardholder device may be mobile device, laptop, desktop, or other computing device. The cardholder device may be the device which requested the DSC, the device which initiated the transaction, or another device. In an example, a cardholder initiates a transaction using a mobile phone, requests a DSC for the transaction using the mobile phone, and receives the DSC at the mobile phone. In an example, the cardholder initiates a transaction using a mobile phone, the DSC is automatically requested based on user preferences, and the cardholder receives the DSC at the mobile phone. In an example, the cardholder initiates a transaction using a laptop computer, the DSC is manually requested by the cardholder using a mobile phone, and the cardholder receives the DSC at the mobile phone.

In some implementations, two-factor authentication (2FA) is used to verify an identity of the cardholder. In an example, the cardholder initiates a transaction, a DSC is manually requested by the cardholder, a 2FA message is sent to a mobile device of the cardholder, the cardholder responds to the 2FA message, and, in response to the 2FA being successful, the DSC is sent to the cardholder. The 2FA message may be sent by a bank system associated with the transaction card.

At operation 440, the card data of the transaction card and the pseudo-random number are stored. The DSC may not be stored. In this way, a security of the DSC is increased, as the DSC itself is not stored. The DSC may be re-generated using the stored card data of the transaction card and the pseudo-random number, but the DSC is not stored. In an example, the card data of the transaction card and the pseudo-random number are stored behind a first authorization check and an algorithm for generating the DSC is stored behind a second authorization check, thus increasing a security of the DSC.

The cardholder may perform a transaction using the DSC. The cardholder may enter the DSC in a field corresponding to a verification value for the transaction. In an example, the cardholder enters the DSC in a card verification value (CVC) field for the transaction on a website of a merchant. In this way, the DSC can be used in the ordinary transaction processing channels. Thus, payment networks do not have to adapt to the use of the DSC and can simply route the DSC in an authorization request in a field used for a card verification value.

At operation 450, an authorization request for a transaction is received via a payment network, the authorization request including the DSC. In some implementations, receiving the authorization request including the DSC includes receiving the DSC in a field of the authorization request corresponding to a card verification number. In an example, an authorization request may include a field for a card verification value that is printed on a transaction card, and the DSC is in the authorization request in that field. In this way, the authorization request does not have to be modified to allow for use of the DSC. Thus, the DSC can be used within conventional authorization requests, allowing for seamless integration with existing authorization channels and payment networks. In some implementations, the DSC has a format (e.g., number of digits) corresponding to a format of a conventional card verification value. In this way, the DSC can be used in conventional authorization channels and authorization requests.

At operation 460, the DSC is generated a second time. The DSC is generated based on the card data of the transaction card and the pseudo-random number. The DSC may be generated using the same data used to generate the DSC the first time and using the same algorithm to generate the DSC. As noted above, by not storing the DSC and instead generating it when needed, a security of the DSC is increased. The DSC is used to authorize the transaction. The generated DSC can be compared to the DSC received in the authorization request to determine whether they match. If the DSC received in the authorization request matches the generated DSC, the authorization can be authorized.

In some implementations, the method 400 includes receiving, via the payment network, a second authorization request including a static card verification number and using the static card verification number to authorize the transaction. Thus, different transactions can use either DSCs or the static card verification number, such as the card verification value printed on the transaction card. In this way, users can request DSCs for added security or use the static card verification number for convenience. As the DSC or the static card verification number can be provided in the same field of an authorization request, the payment network does not have to respond to whether a DSC or the static card verification number is used.

In some implementations, the method 400 includes storing an algorithm for generating the DSC. Generating the DSC the first time and the second time, based on the card data of the transaction card and the pseudo-random number may include generating the DSC using the stored algorithm. In some implementations, the stored algorithm is included in a group of stored algorithms. Generating the DSC the first time and the second time, based on the card data of the transaction card and the pseudo-random number may include selecting the stored algorithm based on the card type of the transaction card. In an example, a first algorithm may be used to generate DSCs for a first payment network using four-digit card verification values and a second algorithm may be used to generate DSCs for a second payment network using three-digit card verification values. In some implementations, a different algorithm is used to generate DSCs for each payment network. In some implementations, different algorithms are used to generate DSCs for each format used by the payment networks. In some implementations, the method 400 includes determining the card type of the transaction card and a payment network associated with the transaction card based on a card number of the transaction card.

In some implementations, the algorithms are implemented using one or more hardware security modules. In an example, a hardware security module is used to store a plurality of algorithms for generating DSCs, where different algorithms are used for different payment networks. In an example, multiple hardware security modules are used to each store a different algorithm.

In some implementations, the method 400 includes querying issuer preferences regarding authorization of DSC transactions and, in response to the authorization request including the static card verification number, authorizing the transaction based on the issuer preferences. In an example, an issuer uses DSCs to approve transactions by default, but allows a transaction to be authorized when the authorization request includes the static card verification number printed on the transaction card. In this way, the issuer can provide the security of DSCs and also provide the convenience of using the static card verification number. In some implementations, the issuer may use additional security tools to determine whether to approve a transaction where a DSC was provided to the cardholder but the authorization request includes the static card verification number.

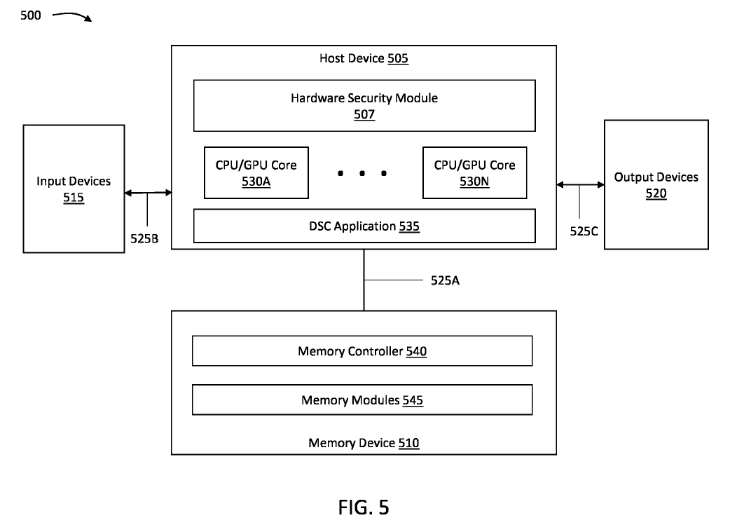

FIG. 5 is an example block diagram of a computing system 500, in accordance with some embodiments of the present disclosure. The computing system 500 includes a host device 505 associated with a memory device 510. The host device 505 may be configured to receive input from one or more input devices 515 and provide output to one or more output devices 520. The host device 505 may be configured to communicate with the memory device 510, the input devices 515, and the output devices 520 via appropriate interfaces or channels 525A, 525B, and 525C, respectively. The computing system 500 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 505.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 500) may be implemented by multiple computing devices in a distributed environment, and vice versa.

The input devices 515 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 505 and that allows an external source, such as a user, computer, or database, to enter information (e.g., data) into the host device and send instructions to the host device 505. Similarly, the output devices 520 may include a variety of output technologies such as external memories, databases, printers, speakers, displays, microphones, light emitting diodes, headphones, plotters, speech generating devices, video devices, and any other output peripherals that are configured to receive information (e.g., data) from the host device 505. The “data” that is either input into the host device 505 and/or output from the host device may include any of a variety of textual data, graphical data, video data, sound data, position data, combinations thereof, or other types of analog and/or digital data that is suitable for processing using the computing system 500.

The host device 505 may include one or more Central Processing Unit (“CPU”) or Graphics Processing Unit (“GPU”) cores or processors 530A-530N that may be configured to execute instructions for running one or more applications associated with the host device 505. In some embodiments, the instructions and data needed to run the one or more applications may be stored within the memory device 510. The host device 505 may also be configured to store the results of running the one or more applications within the memory device 510. One such application on the host device 505 may include a DSC application 535. The DSC application 535 may be executed by one or more of the CPU/GPU cores 530A-530N. The instructions to execute the DSC application 535 may be stored within the memory device 510. The DSC application 535 is described in greater detail above and may perform functions such as described in FIGS. 1-3 and/or methods such as the method 400 of FIG. 4. Thus, the host device 505 may be configured to request the memory device 510 to perform a variety of operations. For example, the host device 505 may request the memory device 510 to read data, write data, update or delete data, and/or perform management or other operations.

The host device 505 may include a hardware security module 507. The hardware security module 507 may be a physical device (hardware) which performs encryption and decryption functions. The hardware security module 507 may be used by the host device 505 to generate DSCs based on transaction card information and pseudo-random numbers, as discussed herein. In some implementations, the host device 505 includes multiple hardware security modules for implementing different DSC algorithms. In an example, the host device 505 includes multiple hardware security modules for implementing different DSC algorithms for different payment networks.

To facilitate communication with the memory device 510, the memory device 510 may include or be associated with a memory controller 540. Although the memory controller 540 is shown as being part of the memory device 510, in some embodiments, the memory controller 540 may instead be part of the host device 505 or another element of the computing system 500 and operatively associated with the memory device 510. The memory controller 540 may be configured as a logical block or circuitry that receives instructions from the host device 505 and performs operations in accordance with those instructions. For example, when the execution of the DSC application 535 is desired, the host device 505 may send a request to the memory controller 540. The memory controller 540 may read the instructions associated with the DSC application 535 that are stored within the memory device 510, and send those instructions back to the host device. In some embodiments, those instructions may be temporarily stored within a memory on the host device 505. One or more of the CPU/GPU cores 530A-530N may then execute those instructions by performing one or more operations called for by those instructions of the DSC application 535.

The memory device 510 may include one or more memory circuits 545 that store data and instructions. The memory circuits 545 may be any of a variety of memory types, including a variety of volatile memories, non-volatile memories, or a combination thereof. For example, in some embodiments, one or more of the memory circuits 545 or portions thereof may include NAND flash memory cores. In other embodiments, one or more of the memory circuits 545 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 510. In some embodiments, one or more of the memory circuits 545 or portions thereof may be configured as other types of storage class memory (“SCM”). Generally speaking, the memory circuits 545 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 500 are shown and described in FIG. 5. However, the computing system 500 may include other components such as various batteries and power sources, networking interfaces, routers, switches, external memory systems, controllers, etc. Generally speaking, the computing system 500 may include any of a variety of hardware, software, and/or firmware components that are needed or considered desirable in performing the functions described herein. Similarly, the host device 505, the input devices 515, the output devices 520, and the memory device 510, including the memory controller 540 and the memory circuits 545, may include hardware, software, and/or firmware components that are considered necessary or desirable in performing the functions described herein. In addition, in certain embodiments, the memory device 510 may integrate some or all of the components of the host device 505, including, for example, the CPU/GPU cores 530A-530N, and the CPU/GPU cores may be configured to execute the DSC application 535, as described herein.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected," or "operably coupled," to each other to achieve the desired functionality, and any two components capable of being so associated can also be viewed as being "operably couplable," to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those instances, where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving a request for a dynamic security code (DSC) for a transaction using a transaction card;
in response to the request:
generating the DSC a first time based on a pseudo-random number and card data of the transaction card including a card type of the transaction card;
transmitting the DSC to a cardholder device;
storing the card data of the transaction card and the pseudo-random number;
receiving, via a payment network, an authorization request for a transaction, the authorization request including the DSC; and
generating the DSC a second time based on the card data of the transaction card and the pseudo-random number to authorize the transaction.

2. The method of claim 1, wherein receiving the authorization request including the DSC comprises receiving the DSC in a field of the authorization request corresponding to a card verification number.

3. The method of claim 1, wherein the card data of the transaction card includes a card number of the transaction card.

4. The method of claim 1, wherein the card type of the transaction card corresponds to a payment network associated with the transaction card.

5. The method of claim 1, further comprising:
receiving, via the payment network, a second authorization request including a static card verification number; and
authorizing the transaction based on the static card verification number.

6. The method of claim 1, further comprising storing an algorithm for generating the DSC, wherein generating the DSC the first time and the second time, based on the card data of the transaction card and the pseudo-random number, includes generating the DSC using the stored algorithm.

7. The method of claim 6, wherein the stored algorithm is included in a group of stored algorithms, and wherein generating the DSC the first time and the second time, based on the card data of the transaction card and the pseudo-random number, includes selecting the stored algorithm based on the card type of the transaction card.

8. The method of claim 1, further comprising determining the card type of the transaction card and a payment network associated with the transaction card based on a card number of the transaction card.

9. The method of claim 1, wherein the pseudo-random number is an incremented number.

10. The method of claim 1, further comprising, in response to the authorization request including a static card verification number:
querying issuer preferences regarding authorization of DSC transactions; and
in response to the authorization request including the static card verification number, authorizing the transaction based on the issuer preferences.

11. A non-transitory, computer-readable medium including instructions which, when executed by one or more processors, cause the one or more processors to:
receive a request for a dynamic security code (DSC) for a transaction using a transaction card;
in response to the request:
generate the DSC a first time, based on a pseudo-random number and card data of the transaction card including a card type of the transaction card;
transmit, to a cardholder device, the DSC;
store the card data of the transaction card and the pseudo-random number;
receive, via a payment network, an authorization request for a transaction, the authorization request including the DSC; and
generate the DSC a second time, based on the card data of the transaction card and the pseudo-random number, to authorize the transaction.

12. The non-transitory, computer-readable medium of claim 11, wherein the instructions cause the one or more processors to receive the authorization request including the DSC by receiving the DSC in a field of the authorization request corresponding to a card verification number.

13. The non-transitory, computer-readable medium of claim 11, wherein the card data of the transaction card includes a card number of the transaction card.

14. The non-transitory, computer-readable medium of claim 11, wherein the card type of the transaction card corresponds to a payment network associated with the transaction card.

15. The non-transitory, computer-readable medium of claim 11, wherein the instructions cause the one or more processors to:
receive, via the payment network, a second authorization request including a static card verification number; and
authorize the transaction based on the card data of the transaction card.

16. The non-transitory, computer-readable medium of claim 11, wherein the instructions cause the one or more processors to:
store an algorithm for generating the DSC, wherein the instructions cause the one or more processors to generate the DSC the first time and the second time, based on the card data of the transaction card and the pseudo-random number, by generating the DSC using the stored algorithm.

17. The non-transitory, computer-readable medium of claim 16, wherein the stored algorithm is included in a group of stored algorithms, and wherein the instructions cause the one or more processors to generate the DSC the first time and the second time, based on the card data of the transaction card and the pseudo-random number, by selecting the stored algorithm based on the card type of the transaction card.

18. The non-transitory, computer-readable medium of claim 11, wherein the instructions cause the one or more processors to determine the card type of the transaction card and a payment network associated with the transaction card based on a card number of the transaction card.

19. The non-transitory, computer-readable medium of claim 11, wherein the pseudo-random number is an incremented number.

20. The non-transitory, computer-readable medium of claim 11, wherein the instructions cause the one or more processors to, in response to the authorization request including a static card verification number:
query issuer preferences regarding authorization of DSC transactions; and
in response to the authorization request including the static card verification number, authorize the transaction based on the issuer preferences.
